(19) United States
(12) Patent Application Publication
(10) Pub. No.: US 2003/0098360 A1
(43) Pub. Date: May 29, 2003

(54) Twin fluid centrifugal nozzle for spray dryers

(76) Inventor: Rakesh Kumar Aggarwal, Port Melbourne (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 09/959,592

(22) PCT Filed: Mar. 2, 2001
(86) PCT No.: PCT/AU01/00215

(30) Foreign Application Priority Data
Mar. 3, 2000 (AU) PQ 5955
Jun. 28, 2000 (AU) PQ 8397

(51) Int. Cl. B05B 7/04

(52) U.S. Cl. 239/8; 239/433

(57) ABSTRACT

A twin fluid centrifugal nozzle for a spray dryer comprises a holder (10) having an annular cavity (11) which holds a sealing ring (12). Above the sealing ring (12) is a large annular recess (13) and an annular passage (14) of slightly increased diameter. The large annular recess (13) seats an orifice disc (16). A vortex chamber block (17) and a twin fluid feed block (18), which are constructed as one piece, are located in the large passage (14). The twin fluid feed block (18) has a passage (19) for air or steam, and a fluid passage (20) for liquid. The orifice disc (16) is a release mechanism for the swirling liquid, in the form of a round disc with apertures therein, through which liquid discharges to form a spray. The swirl or vortex chamber (23) has cyclone shape. One or more atomised liquid inlet passage(s) (24) extend to the vortex chamber (23) in a substantially tangential entry relative to the generally circular cross-section of the chamber (23). Air or steam enters the tangential inlet passage (24), from the passage (19), at a point (26), which is outermost or peripheral, relative to the axis of swirl chamber (23). The liquid flows through the passage (20), and enters the tangential entry passage (24) at a liquid entry point (25), which is located at the venturi point (27) of the tangential entry (24). The liquid enters (25) the stream of air or steam at an angle to the stream, and is pre-atomised in the stream. This pre-atomisation increases the swirl velocity of the liquid in the vortex chamber (23), imparting a higher centrifugal force to liquid droplets emerging from the orifice disc (16).

This invention relates to a twin fluid centrifugal nozzle, and more particularly to a spraying device which uses air/steam to create a centrifugal force and generates the hollow cone spray pattern.

In many spray applications, it is desirable to generate relatively fine spray particles so as to maximise the surface area covered by the spray. Producing droplets of specific size and surface area by atomisation is a critical step in the spray drying process. The degree of atomisation, under a set of drying conditions, controls the drying rate, and therefore the required particle residence time, and therefore the dryer size. There are major differences in the particle size distribution created.

The most commonly employed atomisation techniques are:

1) Pressure Nozzle Atomisation

A spray is created by forcing the fluid through an orifice. The energy required to overcome the pressure drop is supplied by the feed pump. The average particle size produced for a given feed is primarily a function of the flow per nozzle, the nozzle orifice pressure drop.

With pressure nozzle atomisation, one is able to control the spray angle. However, there are capacity limitations, because of potential plugging with the small orifice required.

Furthermore, routine changing of the internal pieces is required. As the pieces are usually made of tunesten carbide, replacement adds significant cost. Additionally, there is an increased safety risk due to pressures as high as 40,000 kPa (400 bar)(400 kg/cm²).

2) Two-Fluid Nozzle Atomisation

In two fluid nozzle atomisation, a spray is created by contacting two fluids, the feed and a compressed gas. The atomisation energy is provided by the compressed gas, usually air. The contact can be internal or external to the nozzle. In such a system, a broad particle size distribution is generated.

Two fluid nozzle atomisation is the least energy efficient of the atomisation techniques. However, it is useful for making extremely fine particles (10 μm (micron) to 30 μm (micron). It is also appropriate for small flow rates typically found in pilot scale dryers.

Such a system requires periodic changing of the air and liquid caps, although it can typically use any type of feed pump. However, control of the spray angle is limited. The spray is in the form of a solid cone which has the potential to heat damage the product.

The capital cost of two fluid nozzle atomisation apparatus can be lower due to the absence of the pressure pump and rotary atomiser.

3) Centrifugal Atomisation

In centrifugal atomisation, a spray is created by passing the fluid across or through a rotating wheel or disc. The energy required for atomisation is supplied by the atomiser motor. A broad particle size distribution is generated.

Centrifugal atomisation requires a relatively high gas inlet velocity to prevent wall buildup, which can increase the amount of fines produced. However, it can generally be run for longer periods of time without operator interface.

Centrifugal atomisation is usually the most resistant to wear. It requires periodic changing of wheel inserts, which are usually made of tungsten carbide. Control of wall buildup is minimal, due to the (horizontal) direction of spray and broad particle size distribution, which forces the dryer to have a relatively large diameter.

The capital cost of a centrifugal atomiser is typically high. A comparatively larger diameter dryer can increase capital cost. As with any high speed rotating machine, maintenance costs are high. The design of the dryer roof and atomiser support add to fabrication cost. Turnaround times for atomiser rebuilds are typically long. Furthermore, a problem with the atomiser will shut down operations.

The above methods have major disadvantages, some of which are listed below.

They require a high pressure homogenising pump. Such pumps are expensive to buy and expensive to run. These are very sensitive to pressure, particulate matter, or product containing fibres. The maintenance cost is very high for a high pressure nozzle system. They have very small turndown ratios. They are also susceptible to erosion because of the high pressure involved. The erosion changes the physical dimensions of the spray nozzle, and as a result spray characteristics.

In the conventional two fluid nozzle as discussed above, most of the energy it supplied by the air or steam, as the case may be. Liquid admitted under low pressure may be mixed either internally or externally with air. The limiting factors in these nozzles are:

In the internally mixed nozzles the spray angle is very narrow. This makes them unsuitable for efficient spray drying. In the externally mixed nozzles, the liquid flow rate and stream diameter is limited in a practical sense by the geometry and configuration necessary to impinge the atomising gas on the liquid. This angle can be no greater than that which the air can impinge upon efficiently.

In some nozzle designs the mixture is made to impinge on an external metal object to spread the angle. This is not suitable for spray drying as the product forms a lump on the impinging piece and this affects the product quality. The product may have high occluded air making the product density quite low.

It is an object of the present invention to provide a means of atomising liquid using air or steam, which overcomes the disadvantages of prior art centrifugal pressure nozzles and two-fluid nozzles.

The invention may provide, in a broad aspect, a twin fluid centrifugal nozzle, characterised in that a first fluid flows as a fluid stream, and in that a second fluid is introduced into said stream, such that said second fluid is pre-atomised in said stream.

Said stream may be in a passage leading to a chamber.

Said chamber may be a vortex chamber.

Said vortex chamber may have a cyclone shape.

Said passage may constitute a tangential entry to said chamber, such that said stream enters said chamber tangentially.

Said second fluid may be introduced into said stream at an angle to said stream. Said angle may be such that said second fluid is introduced into said stream at least in part against said flow.

Said vortex chamber is adapted to atomise said preatomised second fluid, by subjecting said pre-atomised second fluid to centrifugal force.

Said centrifugal force may be produced by using a higher velocity for said firs, fluid.

Said first fluid may be air.

Said first fluid may be compressed air.

Said first fluid may be steam.

The invention may also provide, in a broad aspect, a method of producing a spray of a second liquid, including the steps of providing a stream of a first fluid, and introducing said second fluid into said stream, such that said second fluid is pre-atomised in said stream.

Said method may include the feature that said stream is in a passage leading to a chamber.

Said chamber may be a vortex chamber.

Said vortex chamber may have a cyclone shape.

Said stream may enter said chamber tangentially.

Said method may also include the step of introducing said second fluid to said stream at an angle to said stream.

Said angle may be such that said second fluid is introduced at least in part against the flow of said stream.

Said method may also include the step of subjecting said pre-atomised first fluid and second fluid to centrifugal force, such that said pre-atomised second fluid is atomised.

Said centrifugal force may be applied in said vortex chamber. Said centrifugal force may be obtained by using a higher velocity for the stream of said first fluid.

Said first fluid may be air.

Said first fluid may be compressed air.

Said first fluid may be steam.

The twin fluid centrifugal nozzle of the present invention does not require such high pressure as prior art arrangements, provides a wide and controllable angle, and can be turned down. At the same time it provides a more uniform droplet size distribution, allows a variation in the flow rate and does not use an excessive amount of air.

The twin fluid centrifugal nozzle of this invention is used to achieve a highly controllable droplet size and spray pattern, and is able to handle a wide range of viscosities.

In the nozzle, there is preferably a pre-atomisation step, in which the second fluid (liquid) is pre-atomised within the nozzle into the first fluid (gas) stream, and a atomisation step, in which centrifugal force is created in a vortex chamber in the pre-atomised liquid and gas stream. Pre-atomisation may be described as subdividing the continuous liquid stream. In the preferred apparatus and method, a high centrifugal velocity is achieved, by increasing the volume many fold, using the first fluid. For example, by using compressed air when the gas is air. Higher centrifugal velocity helps to atomise the spray in a wide angle.

In a principal aspect of the present invention, the twin fluid centrifugal which comprises an orifice with an aperture to discharge the liquid at the highest air velocity zone of the centrifugal chamber entry, a centrifugal chamber for mixing and imparting a swirling motion to the fluid and liquid mixture and a discharge nozzle.

An embodiment of the invention, which may be preferred, will be described in detail hereinafter, with reference to the accompanying drawings, in which:—

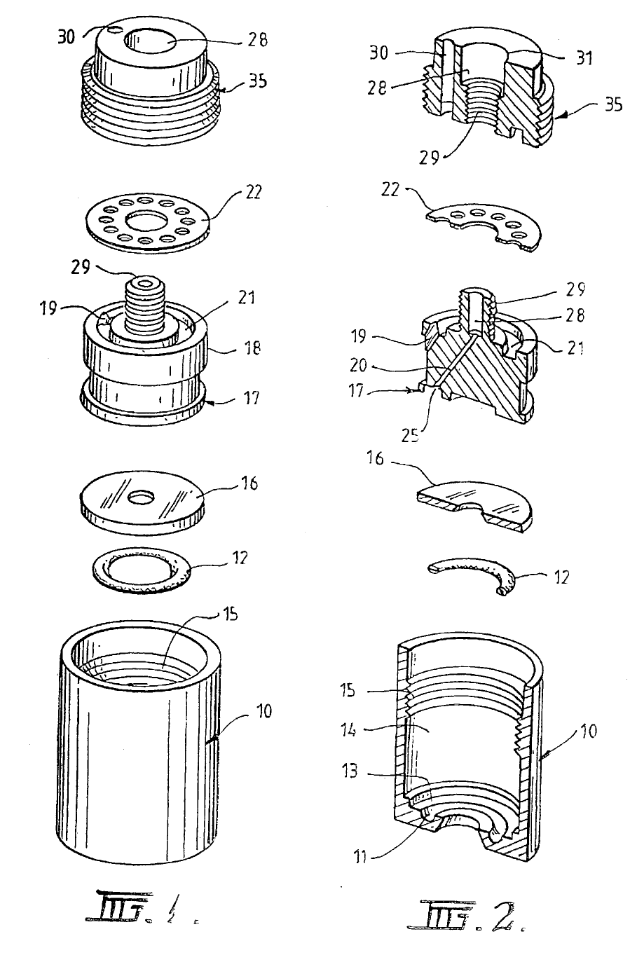

FIG. 1 is an exploded isometric view of an embodiment of twin fluid centrifugal nozzle according to the present invention;

FIG. 2 is an exploded isometric view of the nozzle of FIG. 1, sectioned along the axis thereof;

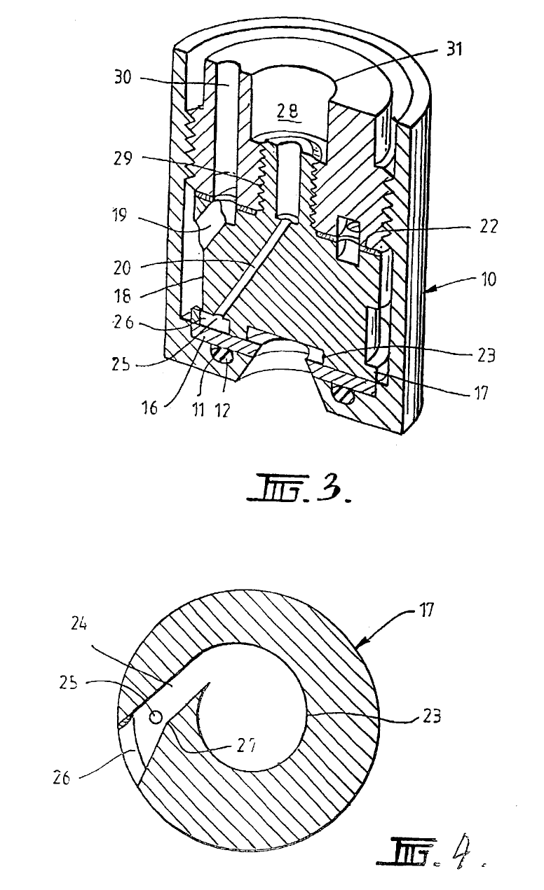

FIG. 3 is a cross-sectional isometric view of the nozzle of FIG. 1, with all its components assembled; and

FIG. 4 is a plan view of the swirl chamber of the nozzle of FIGS. 1 to 3.

The drawings show an embodiment of a twin fluid centrifugal nozzle, which nozzle is constructed in accordance with the principles of the present invention, which is able to carry out the method of the invention, and which is generally in accordance with prototype nozzles constructed and tested.

The nozzle comprises a holder 10 having an annular cavity 11 adapted to hold a sealing ring 12. Above the sealing ring 12 is a large annular recess 13, an annular passage 14 of slightly increased diameter, and a threaded portion 15, each element being aligned with each other along a common axis. The large annular recess 13 retains an orifice disc 16. The large passage 14 defines a vortex chamber block 17 and a twin fluid feed block 18, which are constructed as one piece.

The twin fluid feed block 18 has a passage 19 for air or steam, and a fluid passage 20 for liquid. Gasket 22 seals the liquid and air or steam passages 19, 20 simultaneously. Groove 21 provides a passage communicating with a supply of air or steam, preferably compressed air.

The sealing ring 12 is typically made of an elastomeric material compatible with the operating conditions and the fluids used. The orifice disc 16 is a release mechanism for the swirling liquid. It is typically a round disc with apertures therein, through which the liquid discharges to form a spray.

With particular reference to FIG. 4, the swirl or vortex chamber 23 is of a cyclone shape. One or more atomised liquid inlet passage(s) 24 extend to the vortex chamber 23 in a substantially tangential entry relative to the generally circular swirl chamber 23. Air or steam (a first fluid) enters the tangential inlet passage 24, from passage 19, at point 26, which is outermost or peripheral, relative to the axis of swirl chamber 23. The liquid (a second fluid) enters the tangential inlet, from passage 20, at liquid entry point 25, which is preferably located at the convergence (venturi) point 27 of the tangential entry 24, where the tangential entry 24 converges (FIG. 4).

A feature of the present invention resides in the angular relationship of the air or steam stream at convergence point 27, and passage 20, which ends at the liquid entry 25. As shown in FIG. 4, the angle between the flow, which is substantially in a plane 90° to the axis of the nozzle and tangential to the generally circular vortex chamber 23, and passage 20, is about 75°. The preferred location of the liquid entry 25 is at convergence (venturi) point 27 of the stream of air or steam.

Although it is not fully understood at this time exactly what the nature of the action is which occurs in the vortex chamber 23, which results in a large droplet size in the final nozzle discharge, it is believed that atomisation of the liquid occurs in the air stream. The air is supplied through the entry 26 to the swirl, and has pre-atomised the liquid. The core of the liquid which is being discharged through the discharge orifice disc 16 as shown in FIG. 2.

The intended purpose of the vortex chamber is to provide a small space in which an intense reaction takes place between the pre-atomised liquid and (when air is used) compressed air. The pre-atomised fluid stream is made to spin in the chamber 23. The G-force thus generated is instrumental in controlling the angle of spray. The entry velocity into the chamber 23, the diameter of the chamber 23, the volume of the chamber 23 and the residence time of the fluid in the chamber 23, are parameters which, preferably, are to be optimised.

During passage through the vortex chamber 23, the liquid droplets appear to agglomerate in the vortex chamber 23 such that the spray which is discharged through the discharge orifice disc 16 forms a well defined swirling hollow cone which is filled with droplets of liquid. It is believed that the air atomisation of the liquid increases the total fluid volume thus increasing the swirl velocity in the swirl chamber. The higher swirl velocity imparts a high centrifugal force on the droplets emerging from the discharge orifice disc 16. This centrifugal force makes the droplets behave like a centrifugal atomiser. The spray angle thus obtained from this nozzle is significantly greater. During trials the angle was found to be between 45° and 90°.

The twin fluid feed block 18 and discharge orifice disc 16 are firmly held in place by a threaded nozzle body 35 which is secured into threaded portion 15 and into contact with the rear side of the twin fluid feed block 18. The nozzle body 35 includes a fluid feed 28 and is threaded at its threaded fluid inlet 29. The receipt of a suitable hose or conduit is on the end liquid feed port 31 from a source of liquid (not shown) which liquid is to be discharged through the nozzle. The air or steam is received through air or steam inlet 30 which is connected to a source (not shown).

In operation, liquid is introduced through fluid feed 28 to threaded fluid inlet 29 and angled fluid passage 20 in the twin fluid feed block 18 to the liquid entry 25 into the tangential inlet passage 24 into the vortex chamber 23 defined between the vortex chamber 17 and the orifice disc 16. Air or steam is introduced through air or steam inlet 30 to passage 19 and angled passage 19 around the twin fluid feed body 18 to the air or steam opening of swirl 26 into the tangential inlet passage 24 into the vortex chamber 23 defined between the vortex chamber 17 and the orifice disc 16.

Pre-atomisation of the liquid, in the described embodiment, takes place in the stream of air or steam in entry passage 24, around convergence point 27, and may make use of the Venturi effect. However, different geometry based on mathematical modelling may produce improved pre-atomisation.

This pre-atomised liquid enters the vortex or swirl chamber 23 through tangential inlet passage 24. Swirl is imparted to this liquid in the Vortex chamber 23 due to the angularity of the tangential inlet passage 24. This swirling liquid is discharged through the orifice disc 16 in the form of a hollow cone in a wide spray angle. At this stage the liquid has broken down to very small droplets. The atomisation, the particle size distribution, interaction with the stream of air (or steam) and the drying time are affected by the release mechanism, in the form of the (metering) orifice disc 16. It is desirable to optimise the shape, exit velocity and diameter of the opening and its interaction with the structures producing pre-atomisation and atomisation.

The height of the swirl chambers, diameter and height of the discharge orifice may be varied to chance the spray angle. The air or steam pressure and feed rate of the liquid have an effect on the particle size distribution.

It has been found that the nozzles of the present invention provide a final spray cone having a spray angle which is substantially improved over a prior conventional nozzle. These nozzles do not have high air consumption and are not limited to small spray dryer applications only.

The method and apparatus of the present invention may be used in the manufacture of spray dried food products such as dairy products. In such an application, the liquid (the second fluid) may be milk, and one dairy product may be powdered milk.

The entire contents of the specification and drawings of Australian provisional patent application nos. P05955, filed on Mar. 3, 2000, and P08397, filed on Jun. 28, 2000, are hereby incorporated into the disclosure of this specification.

The claims form part of the disclosure of this specification

1. A twin fluid centrifugal nozzle, characterised in that a first fluid flows as a fluid stream, and in that a second fluid is introduced into said stream, such that said second fluid is pre-atomised in said stream.

2. A twin fluid centrifugal nozzle according to claim a, characterised in that said stream is in a passage leading to a chamber.

3. A twin fluid centrifugal nozzle according to claim 2, characterised in that said chamber is a vortex chamber.

4. A twin fluid centrifugal nozzle according to claim 3, characterised in that said vortex chamber has a cyclone shape.

5. A twin fluid centrifugal nozzle according to any one of claims 2 to 4, characterised in that said passage constitutes a tangential entry to said chamber, such that said stream enters said chamber tangentially.

6. A twin fluid centrifugal nozzle according to claim 5, characterised in that said second fluid is introduced into said stream at an angle to said stream.

7. A twin fluid centrifugal nozzle according to claim 6, characterised in that said angle is such that said second fluid is introduced into said stream at least in part against said flow.

8. A twin fluid centrifugal nozzle according to claim 6 or claim 7, characterised in that said angle is about 75°.

9. A twin fluid centrifugal nozzle according to any one of claims 3 to 8, characterised in that said vortex chamber is adapted to atomise said preatomised second fluid, by subjecting said pre-atomised second fluid to centrifugal force.

10. A twin fluid centrifugal nozzle according to claim 9, characterised in that said centrifugal force is produced by using a higher velocity for said first fluid.

11. A twin fluid centrifugal nozzle according to any preceding claim, characterised in that said first fluid is air.

12. A twin fluid centrifugal nozzle according to claim 11, characterised in that said first fluid is compressed air.

13. A twin fluid centrifugal nozzle according to any one of claims 1 to 10, characterised in that said first fluid is steam.

14. A method of producing a spray of a second fluid, including the steps of providing a stream of a first fluid, and introducing said second fluid into said stream, such that said second fluid is pre-atomised in said stream.

15. A method according to claim 14, characterised in that said stream is in a passage leading to a chamber.

16. A method according to claim 15, characterised in that said chamber is a vortex chamber.

17. A method according to claim 16, characterised in that said vortex chamber has a cyclone shape.

18. A method according to any one of claims 14 to 17, characterised in that said stream enters said chamber tangentially.

19. A method according to any one of claims 14 to 18, characterised by the further step of introducing said second fluid into said stream at an angle to said stream.

20. A method according to claim 19, characterised in that said angle is such that said second fluid is introduced at least in part against the flow of said stream.

21. A method according to claim 20, characterised in that said angle is about 75°.

22. A method according to any one of claims 14 to 21, characterised by the further step of subjecting said pre-atomised first fluid and second fluid to centrifugal force, such that said pre-atomised second fluid is atomised.

23. A method according to claim 22, characterised in that said centrifugal force is applied in said vortex chamber.

24. A method according to claim 22 or 23, characterised in that said centrifugal force is produced by using a higher velocity for the stream of said first fluid.

25. A method according to any one of claims 14 to 24, characterised in that said first fluid is air.

26. A method according to claim 25, characterised in that said first fluid is compressed air.

27. A method according to any one of claims 14 to 24, characterised in that said first fluid is steam.
